(19) United States
(12) Patent Application Publication
(10) Pub. No.: US 2012/0205206 A1
(43) Pub. Date: Aug. 16, 2012

(54) Hydraulic Buffer Device

(75) Inventors: Jian-Yu Chen, New Taipei City (TW); Ming-Liang Wong, New Taipei City (TW); Chih-Ming Yu, New Taipei City (TW); Wun-Ya Gao, New Taipei City (TW); Jian-Hong Lin, New Taipei City (TW)

(73) Assignee: TEH LIN PROSTHETIC & ORTHOPAEDIC INC., New Taipei City (TW)

(21) Appl. No.: 13/342,922

(22) Filed: Jan. 3, 2012

(30) Foreign Application Priority Data
Feb. 10, 2011 (TW) 100202567

(51) Int. Cl. F16F 9/08

(52) U.S. Cl. 188/269

(57) ABSTRACT

A hydraulic buffer device includes a first chamber, a second chamber, and a buffering space disposed under the first and second chambers, an air bladder disposed in the buffering space, an oil chamber disposed above the first and second chambers and divided by a piston into upper and lower chamber portions, and an annular passage disposed around the oil chamber. When the piston is moved downwardly within the oil chamber, the hydraulic oil flows from the lower chamber portion into the buffering space via the first chamber to contract the air bladder so that, upon expansion of the air bladder, air pressure in the air bladder pushes the hydraulic oil to flow from the buffering space into the upper chamber portion via the second chamber and the annular passage.

### CROSS-REFERENCE TO RELATED APPLICATION

This application claims priority of Taiwanese Application No. 100202567, filed on Feb. 10, 2011.

### BACKGROUND OF THE INVENTION

1. Field of the Invention

This invention relates to a hydraulic device, and more particularly to a hydraulic buffer device that is provided with a pneumatic buffer and that is applicable to a prosthetic leg.

2. Description of the Related Art

A pneumatic buffer has been applied to an artificial knee joint. For example, Taiwanese patent Nos. M275822 and M537892 disclose such a pneumatic buffer. A hydraulic buffer has been also applied to an artificial knee joint. For example, Taiwanese patent Nos. M315084 and M256156 disclose such an artificial knee joint. It is desirable that a pneumatic buffer cooperates with a hydraulic buffer to promote the buffering effect.

### SUMMARY OF THE INVENTION

The object of this invention is to provide a hydraulic buffer device that includes a pneumatic buffer.

According to this invention, a hydraulic buffer device includes a first chamber, a second chamber, and a buffering space disposed under the first and second chambers, an air bladder disposed in the buffering space, an oil chamber disposed above the first and second chambers and divided by a piston into upper and lower chamber portions, and an annular passage disposed around the oil chamber. When the piston is moved downwardly within the oil chamber, the hydraulic oil flows from the lower chamber portion into the buffering space via the first chamber to contract the air bladder so that, upon expansion of the air bladder, air pressure in the air bladder pushes the hydraulic oil to flow from the buffering space into the upper chamber portion via the second chamber and the annular passage.

As such, the air bladder acts as a pneumatic buffer to promote the buffering effect of the hydraulic buffer device.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is an assembled perspective view of the preferred embodiment of a hydraulic buffer device according to this invention;

FIG. 2 is an exploded perspective view of the preferred embodiment;

FIG. 3 is a sectional view taken along Line III-III in FIG. 1, illustrating a damping-adjusting mechanism;

FIG. 4 is a schematic sectional view of the preferred embodiment, illustrating the flow path of the hydraulic oil flowing from a lower chamber portion of an oil chamber into a third chamber during downward movement of a piston;

FIG. 5 is a schematic sectional view of the preferred embodiment, illustrating the flow path of the hydraulic oil flowing from the third chamber into an upper chamber portion of the oil chamber during the downward movement of the piston;

FIG. 6 is a schematic sectional view of the preferred embodiment, illustrating the flow path of the hydraulic oil flowing from the upper chamber portion of the oil chamber into the third chamber during upward movement of the piston; and

FIG. 7 is a schematic sectional view of the preferred embodiment, illustrating the flow path of the hydraulic oil flowing from the third chamber into the lower chamber portion of the oil chamber during the upward movement of the piston.

### DETAILED DESCRIPTION OF THE PREFERRED EMBODIMENT

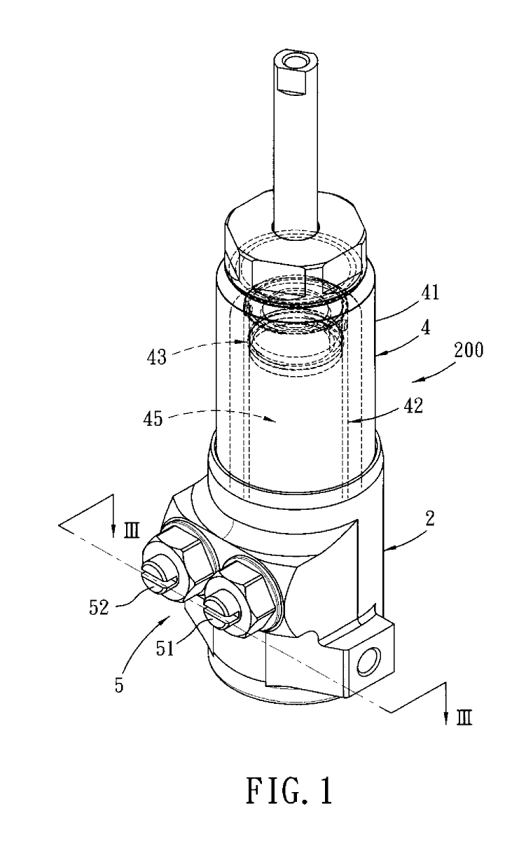

Referring to FIGS. 1, 2, 3, and 4, the preferred embodiment of a hydraulic buffer device 200 according to this invention includes a housing 2, an air bladder 3 disposed in the housing 2, a piston unit 4, and a damping-adjusting mechanism 5.

The housing 2 includes a housing body 20. The housing body 20 has first and second chambers 21, 22 filled with a hydraulic oil, a buffering space 23 disposed under the first and second chambers 21, 22, and a bottom surface formed with a threaded opening 24. The housing 2 further includes a bottom cover 25. The bottom cover 25 has an externally threaded portion 250 engaging the threaded opening 24 in the housing body 20, a bladder-engaging portion 251, and an air valve 252. The buffering space 23 is disposed among the bottom cover 25 and the first and second chambers 21, 22.

The air bladder 3 is disposed within the buffering space 23, and is sleeved on the bladder-engaging portion 251 of the bottom cover 25, such that the buffering space 23 is divided by the air bladder 3 into an air chamber 231 disposed inside the air bladder 3, and a third chamber 232 disposed outside the air bladder 3, in fluid communication with the first and second chambers 21, 22, and filled with the hydraulic oil. An insert gas (such as nitrogen gas) is filled into the air bladder 2 through the air valve 252. In this embodiment, the air pressure in the air bladder 3 is between 100 and 300 psi.

The piston unit 4 includes an outer tube 41 connected fixedly to the housing body 20 of the housing 2, an inner tube 42 disposed fixedly within the outer tube 41 and cooperating with the outer tube 41 and the housing 2 to define a cylindrical oil chamber 40 disposed inside the inner tube 42 and above the first and second chambers 21, 22, a piston 43 disposed movably within the oil chamber 40 and dividing the oil chamber 40 into an upper chamber portion 44 disposed above the piston 43, and a lower chamber portion 45 disposed under the piston 43 and in fluid communication with the first chamber 21, and a piston rod 47 disposed above and connected fixedly to the piston 43.

The inner and outer tubes 41, 42 cooperate to define an annular passage 46 therebetween. The annular passage 46 is in fluid communication with the second chamber 22 and the upper chamber portion 44, and is filled with the hydraulic oil.

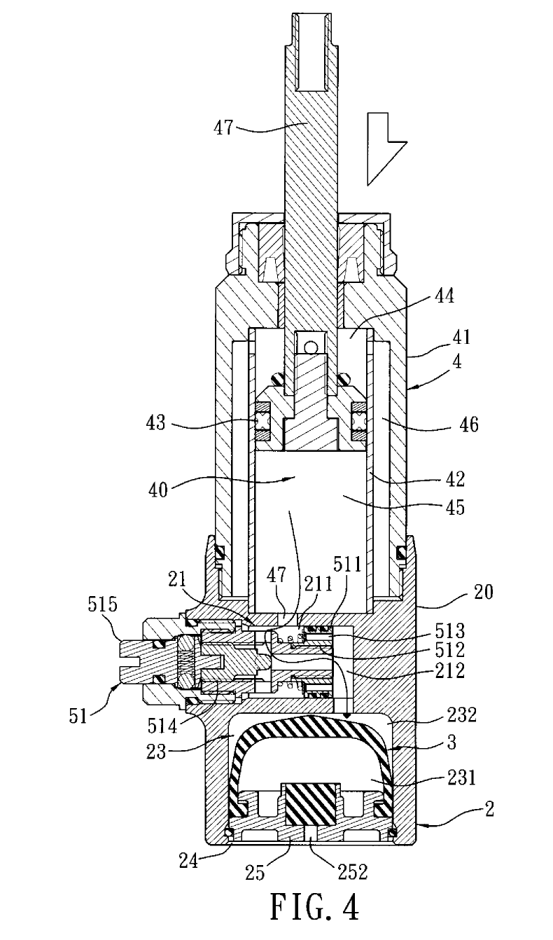

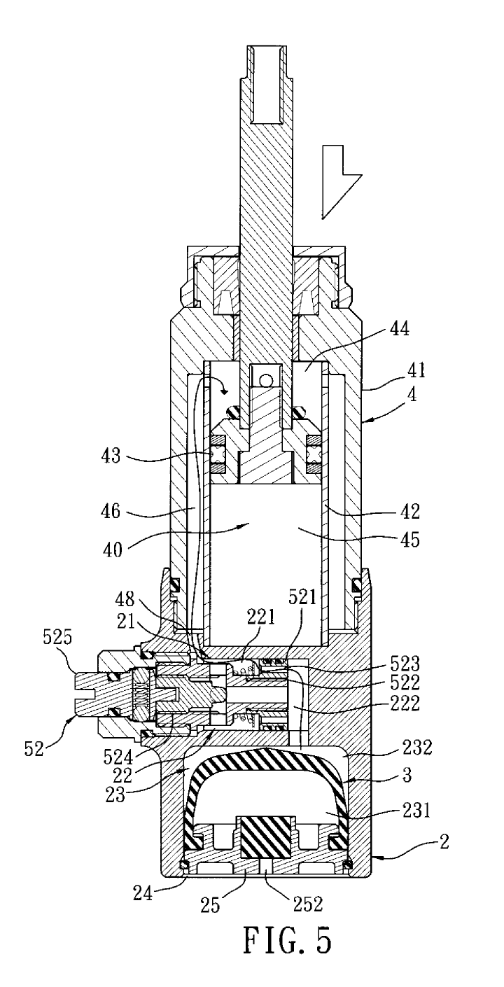

With particular reference to FIGS. 4 and 5, when the piston 43 is moved downwardly within the oil chamber 40, the hydraulic oil flows from the lower chamber portion 45 into the third chamber 232 via the first chamber 21 to contract the air bladder 3 to thereby compress the air chamber 231. Upon expansion of the air bladder 3, the air pressure in the air bladder 3 pushes the hydraulic oil to flow from third chamber 232 into the upper chamber portion 44 via the second chamber 22 and the annular passage 46.

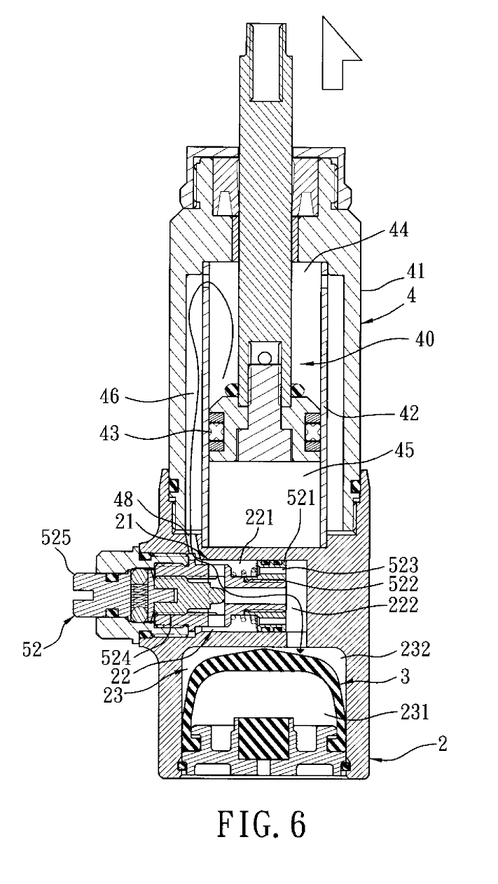

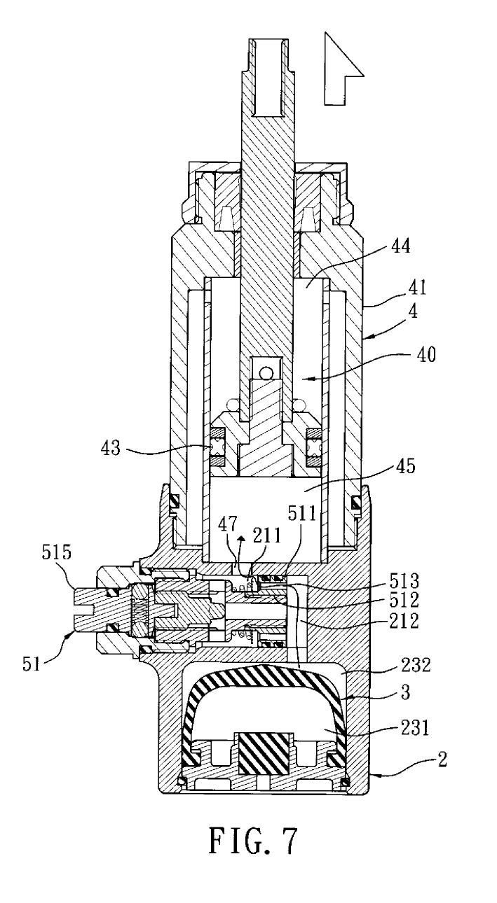

With particular reference to FIGS. 6 and 7, when the piston 43 is moved upwardly within the oil chamber 40, the hydraulic oil flows from the upper chamber portion 44 into the third chamber 232 via the annular passage 46 and the second chamber 22 to contract the air bladder 3 to thereby compress the air chamber 231. Upon the expansion of the air bladder 3, the air pressure in the air bladder 3 pushes the hydraulic oil to flow from the third chamber 232 into the lower chamber portion 45 via the first chamber 21.

The damping-adjusting mechanism 5 includes first and second adjusting units 51, 52 disposed respectively in the first and second chambers 21, 22. The first adjusting unit 51 is operable to adjust the flow rate of the hydraulic oil flowing from the lower chamber portion 45 into the third chamber 232 during downward movement of the piston 43 within the oil chamber 40. The second adjusting unit 52 is operable to adjust the flow rate of the hydraulic oil flowing from the upper chamber portion 44 into the third chamber 232 during upward movement of the piston 43 within the oil chamber 40.

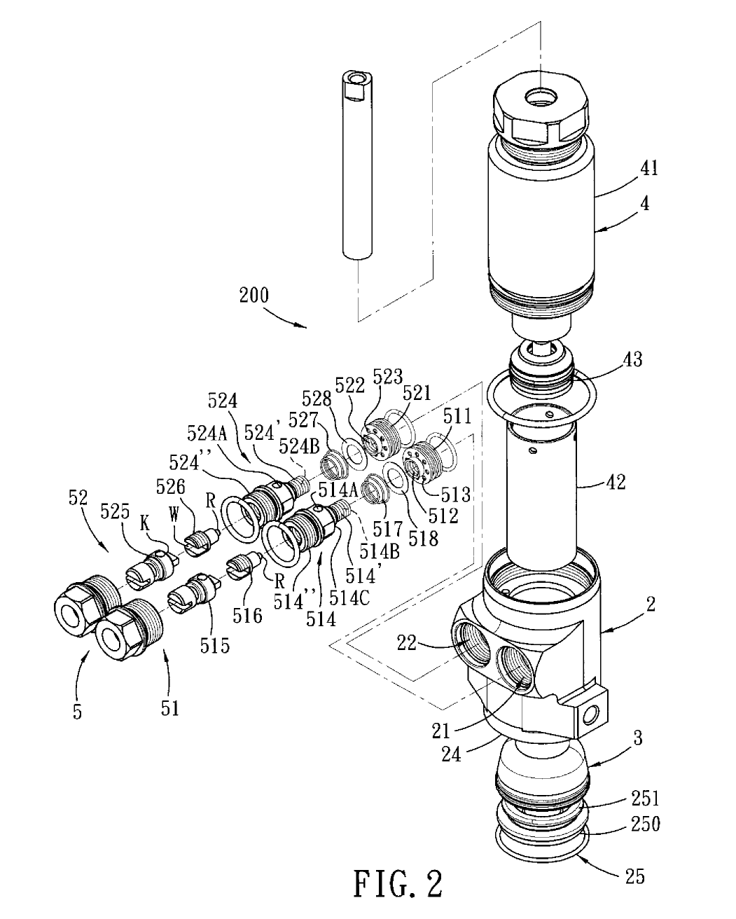

With particular reference to FIGS. 2, 3 and 4, the first adjusting unit 51 includes a partitioning member 511 that is disposed fixedly in the first chamber 21 to divide the first chamber 21 into an upstream chamber portion 211 in fluid communication with the lower chamber portion 45 and that has a threaded central bore 512, and a downstream chamber portion 212 in fluid communication with the third chamber 232, such that the central bore 512 has two ends in fluid communication with the upstream and downstream chamber portions 211, 212, respectively. Similarly, the second adjusting unit 52 includes a partitioning member 521 that is disposed fixedly in the second chamber 22 to divide the second chamber 22 into an upstream chamber portion 221 in fluid communication with the annular passage 46 and that has a threaded central bore 522, and a downstream chamber portion 222 in fluid communication with the third chamber 232, such that the central bore 522 has two ends in fluid communication with the upstream and downstream chamber portions 221, 222, respectively.

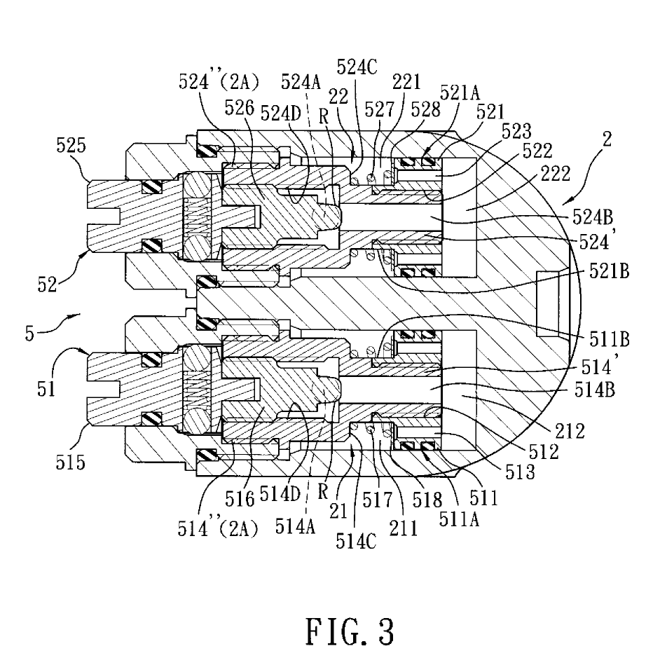

Each of the first and second adjusting units 51, 52 further includes an oil passage member 514, 524 having an externally threaded thin end portion 514′, 524′ engaging the threaded central bore 512, 522 in the partitioning member 511, 52, and an externally threaded thick end portion 514″, 524″ opposite to the thin end portion 514′, 524′ and engaging an internally threaded wall portion 2A (see FIG. 3) of the housing 2. The oil passage member 514, 524 is formed with an upstream passage 514A, 524A in fluid communication with the upstream chamber portion 211, 221, and a downstream passage 514B, 524B disposed between and in fluid communication with the downstream chamber portion 212, 222 and the upstream passage 514A, 524A.

Each of the first and second adjusting units 51, 52 further includes a rotary knob 515, 525 disposed rotatably in the housing 2 and operable by a tool, such as a screwdriver, an externally threaded valve member 516, 526 engaging an internally threaded portion 514D (see FIG. 3) of the oil passage member 514, 524, a resilient member 517, 527, and an annular seal 518, 528. The rotary knob 515, 525 is formed with a key (K) (see FIG. 3) engaging a keyway (W) (see FIG. 3) in the valve member 516, 526, so that the valve member 516, 526 is co-rotatable with the rotary knob 515, 525.

As such, upon rotation of the rotary knob 511, 521, the valve member 516, 526 is move toward or away from the downstream passage 514B, 524B in the oil passage member 514, 524 to change the width of a clearance between a rounded end (R) (see FIG. 2) of the valve member 516, 526 and a wall of the oil passage member 519, 529 defining an adjacent end of the downstream passage 514B, 524B. In this manner, by adjusting the position of the valve member 516 of the first adjusting unit 51, the flow rate of the hydraulic oil flowing from the lower chamber portion 45 into the third chamber 232 can be changed, and by adjusting the position of the valve member 526 of the second adjusting unit 52, the flow rate of the hydraulic oil flowing from the upper chamber portion 44 into the third chamber 232 can be changed.

In this embodiment, the partitioning member 511, 521 has a thick portion 511A, 521A attached fixedly to a wall defining a corresponding one of the first and second chambers 21, 22, and a thin portion 511B, 521B having an outer diameter smaller than that of the thick portion 511A, 521A and connected to the thick portion 511A, 521A at an end thereof. The central bore 512, 522 extends through the thick portion 511A, 521A and the thin portion 511B, 521B. The partitioning member 511, 521 further has a plurality of axial holes 513, 523 formed through the thick portion 511A, 521A and parallel to and disposed around the central bore 512, 522.

The annular seal 518, 528 is sleeved movably on the thin portion 511B, 521B of the partitioning member 511, 521.

The oil passage member 514, 524 is formed with a shoulder 514C, 524C. In this embodiment, the resilient member 517, 527 is configured as a coiled compression spring sleeved on the thin portion 511B, 521B of the partitioning member 511, 521 and disposed between and abutting against the shoulder 514C, 524C and the annular seal 518, 528 for biasing the annular seal 518, 528 to abut against the partitioning member 511, 521 so as to seal the axial holes 513, 523, thereby preventing flow of the hydraulic oil from the upstream chamber portion 211, 221 into the downstream chamber portion 212, 222 through the axial holes 513, 523, while allowing for flow of the hydraulic oil from the downstream chamber portion 212, 222 into the upstream chamber portion 211, 221 through the axial holes 513, 523.

As such, during the downward movement of the piston 43, the hydraulic oil flows from the upstream chamber portion 211 of the first chamber 21 into the downstream chamber portion 212 of the first chamber 21 through the oil passage member 514 of the first adjusting unit 51, as shown in FIG. 4, and from the downstream chamber portion 222 of the first chamber 22 into the upstream chamber portion 221 of the first chamber 22 through the axial holes 523 in the partitioning member 521 of the second adjusting unit 52, as shown in FIG. 5.

In view of the above, due to the presence of the air bladder 3 acting as a pneumatic buffer, the buffering effect of the hydraulic buffer device is promoted. Thus, the object of this invention is achieved.

With this invention thus explained, it is apparent that numerous modifications and variations can be made without departing from the scope and spirit of this invention. It is therefore intended that this invention be limited only as indicated by the appended claims.

We claim:

1. A hydraulic buffer device comprising:
a housing including a housing body, said housing body having a first chamber, a second chamber, and a buffering space disposed under said first and second chambers;
an air bladder disposed within said buffering space to divide said buffering space into an air chamber disposed inside said air bladder and filled with a gas, and a third chamber disposed outside said air bladder;
a piston unit including an outer tube connected fixedly to said housing body of said housing, an inner tube disposed fixedly within said outer tube and cooperating with said outer tube and said housing to define a cylindrical oil chamber disposed inside said inner tube and above said first and second chambers, a piston disposed movably within said oil chamber and dividing said oil chamber into an upper chamber portion disposed above said piston, and a lower chamber portion disposed under said piston, and a piston rod disposed above and connected fixedly to said piston, said inner and outer tubes cooperating to define an annular passage therebetween, said lower chamber portion being in fluid communication with said first chamber and adapted to be filled with a hydraulic oil, said annular passage being in fluid communication with said upper chamber portion and said second chamber and being adapted to be filled with the hydraulic oil; and
a damping-adjusting mechanism including first and second adjusting units disposed respectively in said first and second chambers, said first adjusting unit being operable to adjust the flow rate of the hydraulic oil flowing from said lower chamber portion into said third chamber during downward movement of said piston within said oil chamber, said second adjusting unit being operable to adjust the flow rate of the hydraulic oil flowing said upper chamber portion into said third chamber during upward movement of said piston within said oil chamber;
wherein, when said piston is moved downwardly within said oil chamber, the hydraulic oil flows from said lower chamber portion into said third chamber via said first chamber to contract said air bladder to thereby compress said air chamber, so that, upon expansion of said air bladder, air pressure in said air bladder pushes the hydraulic oil to flow from said third chamber into said upper chamber portion via said second chamber and said annular passage; and when said piston is moved upwardly within said oil chamber, the hydraulic oil flows from said upper chamber portion into said third chamber via said annular passage and said second chamber to contract said air bladder to thereby compress said air chamber, so that, upon expansion of said air bladder, air pressure in said air bladder pushes the hydraulic oil to flow from said third chamber into said lower chamber portion via said first chamber.

2. The hydraulic buffer device as claimed in claim 1, wherein said first adjusting unit includes:
a partitioning member disposed fixedly in said first chamber and dividing said first chamber into an upstream chamber portion in fluid communication with said lower chamber portion, and a downstream chamber portion in fluid communication with said third chamber, said partitioning member having a threaded central bore formed therethrough, said central bore having two ends in fluid communication with said upstream and downstream chamber portions, respectively;
an oil passage member having a threaded thin end portion engaging said threaded central bore in said partitioning member, an upstream passage in fluid communication with said upstream chamber portion, and a downstream passage disposed between and in fluid communication with said downstream chamber portion and said upstream passage;
a valve member threaded into said oil passage member and having a rounded end adjacent to an end of said downstream passage in said oil passage member and spaced apart from a wall of said oil passage member defining said end of said downstream passage; and
a rotary knob disposed rotatably on said housing and connected co-rotatably to said valve member, such that said rotary knob is operable to move said valve member toward or away from said downstream passage in said oil passage member, so as to change of the width of a clearance between said rounded end of said valve member and said wall defining said end of said downstream passage, thereby adjusting the flow rate of the hydraulic oil flowing between said upstream and downstream chamber portions through said upstream and downstream passages.

3. The hydraulic buffer device as claimed in claim 2, wherein said partitioning member has a thick portion attached fixedly to a wall of said housing defining said first chamber, and a thin portion having an outer diameter smaller than that of said thick portion and connected to said thick portion at an end thereof, said central bore extending through said thick portion and said thin portion, said partitioning member further having a plurality of axial holes formed through said thick portion and parallel to and disposed around said central bore, said oil passage member being further formed with a shoulder, said first adjusting unit further including an annular seal sleeved movably on said thin portion of said partitioning member, and a resilient member sleeved on said thin portion of said partitioning member and disposed between and abutting against said shoulder of said oil passage member and said annular seal for biasing said annular seal to abut against said partitioning member so as to seal said axial holes, thereby preventing flow of the hydraulic oil from said upstream chamber portion into said downstream chamber portion through said axial holes, while allowing for flow of the hydraulic oil from said downstream chamber portion into said upstream chamber portion through said axial holes.

4. The hydraulic buffer device as claimed in claim 1, wherein said second adjusting unit includes:
a partitioning member disposed fixedly in said second chamber and dividing said second chamber into an upstream chamber portion in fluid communication with said annular passage, and a downstream chamber portion in fluid communication with said third chamber, said partitioning member having a threaded central bore formed therethrough, said central bore having two ends in fluid communication with said upstream and downstream chamber portions, respectively;
an oil passage member having a threaded thin end portion engaging said threaded central bore in said partitioning member, an upstream passage in fluid communication with said upstream chamber portion, and a downstream passage disposed between and in fluid communication with said downstream chamber portion and said upstream passage;
a valve member threaded into said oil passage member and having a rounded end adjacent to an end of said downstream passage in said oil passage member and spaced apart from a wall of said oil passage member defining said end of said downstream passage; and
a rotary knob disposed rotatably on said housing and connected co-rotatably to said valve member, such that said rotary knob is operable to move said valve member toward or away from said downstream passage in said oil passage member, so as to change of the width of a clearance between said rounded end of said valve member and said wall defining said end of said downstream passage, thereby adjusting the flow rate of the hydraulic oil flowing between said upstream and downstream chamber portions through said upstream and downstream passages.

5. The hydraulic buffer device as claimed in claim 4, wherein said partitioning member has a thick portion attached fixedly to a wall of said housing defining said second chamber, and a thin portion having an outer diameter smaller than that of said thick portion and connected to said thick portion at an end thereof, said central bore extending through said thick portion and said thin portion, said partitioning member further having a plurality of axial holes formed through said thick portion and parallel to and disposed around said central bore, said oil passage member being further formed with a shoulder, said first adjusting unit further including an annular seal sleeved movably on said thin portion of said partitioning member, and a resilient member sleeved on said thin portion of said partitioning member and disposed between and abutting against said shoulder of said oil passage member and said annular seal for biasing said annular seal to abut against said partitioning member so as to seal said axial holes, thereby preventing flow of the hydraulic oil from said upstream chamber portion into said downstream chamber portion through said axial holes, while allowing for flow of the hydraulic oil from said downstream chamber portion into said upstream chamber portion through said axial holes.

6. The hydraulic buffer device as claimed in claim 1, wherein said housing body further has a bottom surface formed with a threaded opening, and said housing further includes a bottom cover having an externally threaded portion engaging said threaded opening in said housing body, a bladder-engaging portion permitting said air bladder to be sleeved thereon, and an air valve in fluid communication with said air chamber and adapted to permit the gas to be filled into said air bladder therethrough.

7. The hydraulic buffer device as claimed in claim 1, wherein the gas is an inert gas, and the air pressure in said air bladder is between 100 and 300 psi.
